(19) United States
(12) Patent Application Publication
(10) Pub. No.: US 2011/0180170 A1
(43) Pub. Date: Jul. 28, 2011

(54) DIRECTIONAL FLOW-CONTROLLED AIR DUCT

(75) Inventor: Anders Olsen, Esbjerg (DK)

(73) Assignee: KE FIBERTEC A/S, Vejen (DK)

(21) Appl. No.: 13/010,407

(22) Filed: Jan. 20, 2011

Related U.S. Application Data
(60) Provisional application No. 61/297,360, filed on Jan. 22, 2010.

(30) Foreign Application Priority Data
Jan. 28, 2010 (EP) 10151870.2

(51) Int. Cl. F16L 25/00

(52) U.S. Cl. 138/37

(57) ABSTRACT

The invention relates to a directional flow-controlled air duct having a pliable wall and a plurality of openings for discharging air through the openings. The air duct is characterized in that a number of the plurality of openings are provided with a guiding portion for guiding the air through the openings, such that the guiding portion, when air is discharged through the openings provided with guiding portions, is deflected by the air from the opening, and that the guiding portion resulting in the air, when air discharged through the openings provided with guiding portions, is directed along the guiding portion

### CROSS-REFERENCE TO RELATED APPLICATIONS

This application is a non-provisional of and claims the benefit of priority to U.S. provisional Patent Application Ser. No. 61/297,360, filed on Jan. 22, 2010, and European Application No. 10151870.2, filed on Jan. 28, 2010, the disclosures of which are hereby expressly incorporated by reference in their entireties.

### FIELD OF THE INVENTION

The subject invention generally pertains to pliable material air ducts and more specifically to openings in such pliable material air ducts, where air when discharged through said opening is guided by a guiding portion of the pliable wall.

### BACKGROUND OF THE INVENTION

Air ducts are often used to convey conditioned air (e.g., heated, cooled, filtered, etc.) discharged from a central air conditioner to distribute the conditioned air to a room or other areas within a building. Ducts are typically formed of rigid metal, such as steel, aluminum, or stainless steel. In many installations, ducts are hidden above suspended ceilings for convenience and aesthetics. But in warehouses, manufacturing plants and many other buildings, the ducts are suspended from the roof of the building and are thus exposed. Metal ducts can present problems in terms of accumulated dirt. For example, temperature variations in the building or temperature differentials between the ducts and the air being conveyed can create condensation on both the interior and exterior of the ducts. The presence of condensed moisture on the interior of the duct may form mold or bacteria that the duct then passes onto the room or other areas being supplied with the conditioned air. In the case of exposed ducts, condensation on the exterior of the duct can drip onto the inventory or personnel below.

Further, metal ducts with localized discharge registers have been known to create uncomfortable drafts and unbalanced localized heating or cooling within the building. In facilities where the target temperature is low say around 5 degrees Celsius, a cold draft can be especially uncomfortable and possibly unhealthy.

Many of the above problems associated with metal ducts are overcome by the use of pliable material ducts, such as a Textile Based Ventilation (TBV) from KE Fibertec of Vejen, Denmark. Such ducts typically have a flexible fabric wall that inflates to a generally cylindrical shape by the pressure of the air being conveyed by the duct. Fabric ducts seem to inhibit the formation of condensation on its exterior wall, possibly due to the fabric having a lower thermal conductivity than that of metal ducts. In addition, the fabric's porosity and/or additional holes distributed along the length of the fabric duct broadly and evenly disperse the air into the room being conditioned or ventilated. The even distribution of airflow also effectively ventilates the walls of the duct itself, thereby further inhibiting the formation of mold and bacteria. Furthermore, as opposed to metal ducts, pliable material ducts can be dismantled and washed frequently in a conventional laundry.

However, it is a well known problem in the field of duct ventilation, that problems with entrainment of the discharged air flow from the duct along the longitudinal direction of the duct, is unavoidable when discharging air through openings in the duct. This problem is conventionally met in both metal and pliable wall ducts by installing various types of nozzles in the duct wall to direct the discharged air through the opening. In pliable material ducts the introduction of nozzles impose a dramatic increase in the cost of the duct system, the handling of the ducts and the maintenance of the ducts and hence an improved pliable material air duct would be advantageous, and in particular an air duct with enhanced possibilities of controlling the entrainment of the discharged air and lowering the cost of the production of the air duct

### SUMMARY OF THE INVENTION

Aspects of the invention may be to provide an air duct made from a pliable material and which air duct capable of guiding air in a specific direction when discharged from the air duct.

It may be a further aspect of the present invention to provide an alternative to the prior art.

In particular, it may be seen as an aspect of the present invention to provide an air duct made from a pliable material that solves the above mentioned problems of the prior art with entrainment of the discharged air along the longitudinal direction of the air duct.

Thus, the above described embodiments are provided in a first aspect of the invention by providing an entrainment-controlled air duct for distributing air, said duct having a pliable wall comprising a plurality of openings for discharging the air through the plurality of openings, and characterized in that

at least a number of said plurality of openings is provided with a guiding portion for guiding the air through the openings,

said guiding portion, when air is discharged through the plurality of openings provided with guiding portions, being deflected by the air from the opening, and

said guiding portion resulting in the air, when air is discharged through the plurality of openings being provided with guiding portions, being directed along the guiding portion.

It is to be understood, that when using the phrase “air duct” the wording covers any shape or type of an air duct having a main body made form a pliable material, and from which air duct air is discharged through openings in the air duct.

It is to be understood, that when using the phrase “air” the wording covers any type of substance in the gaseous state such as atmospheric air, atmospheric air with added content element(s), atmospheric air with removed content element(s), conditioned atmospheric air conditioned in terms of temperature, pure gasses and mixed gasses.

It is to be understood, that when using the phrase “pliable wall” the wording covers walls made from any type of a pliable material (pliable referring to the bending properties of the material), such as fabrics, flexible plastics, latex, thin foils etc. The wall being pliable refers to the ability of the ventilated air to deform the wall, which means that e.g. metals which are able to be bend by excessive force do not fall into this definition of pliable.

The guiding portions according to the invention, when air is discharged through the air duct, deflect away from the surface of the pliable wall to act as guiding portion for air discharged through an air duct according to the invention. This definition seeks to avoid misunderstandings of the guiding portion being only a part of the wall near the edge of the opening but not extending away from the surface of the wall thereby defining the shape of the opening.

The air duct according to the invention is used for distributing and discharging air in indoor ventilation systems, the air typically provided by a central air-condition system such as a heating/cooling system, an air cleaning system, an air dehumidifying system etc. Indoor ventilations systems may in any type and size of enclosure for humans and/or animals and/or goods, i.e. buildings, tents, containers etc.

According to a preferred embodiment of the invention, the guiding portion is provided by a through cut, along a boundary of the opening, of a first part of the material which the pliable wall is made of, and by a non-through cut, also along the boundary of the opening, of another part of the material which the pliable wall is made of

By cutting the pliable wall along one part of the boundary of an opening and not cutting through the material along the remaining part of the boundary of the opening, the guiding portion is made directly from a part of the pliable wall, which makes the air duct comprising guiding portions easy and cheap to manufacture compared to assembly with a separate guiding portion made from another piece of pliable material or a solid material, as in the nozzle-type guiding portions known in the prior art.

It is to be understood, that the above used phrase “cutting” covers all ways of cutting through the material of the pliable wall such as punching, stamping, laser cutting, water cutting, melting etc.

According to another preferred embodiment of the invention, the openings comprise a first set of openings not provided with guiding portions, and at least a second set of openings provided with guiding portions. Thus, the air duct may consist of several different types of guiding portions resulting in air, when discharged through said set of openings, constituting an air flow which substantially spans a predefined angle in a predefined distance from the air duct in a predefined direction.

With techniques such as CNC cutting, the ability to make large sets of different cuts through the pliable wall makes it possible to tailor-make air ducts for specific purposes such as ventilation of a room with specific dimensions or ventilation of a room with specific ventilation zones in a room without adding significantly to the cost of the air duct.

The ability of dimensioning a set of openings not provided with guiding portions and openings provided with guiding portions allows one to effectively span a certain angle in a specific distance and in a specific direction provides a very complex ventilation scheme, which can be set up to exactly match the need in a given room or premise. By adding to the size of such a set of openings and openings with guiding portions the complexity of the flow patterns of the discharged air from the air duct can be increased.

According to yet another preferred embodiment of the invention, the other part of the material which the pliable wall is made of and which is non-through cut, along the boundary of the opening, has a texture being different than a texture in immediate vicinity of said other part, said different texture being provided by heat treatment of the material which the pliable wall is made of, said different texture of the other part resulting in the guiding portion, when air is discharged through the plurality of openings provided with guiding portions, being deflected from the opening a certain degree depending on a flow speed and a flow volume of the air being discharged.

The flexibility of the pliable wall around the openings provided with guiding portions, when the guiding portions are made from a part of the pliable wall, can be altered in the cutting step of the manufacturing when using techniques with heat distribution such as laser cutting, melting, heated stamp stamping etc. In this way the flexibility of the material around the openings including the guiding portions, when these are made from a part of the pliable wall, can be altered to be either stiffer or more pliable depending on the need for deflecting the air being discharged through the openings provided with guiding portions. Since heat treatment of the pliable wall material can be done in the same process step as the cutting, possibly using the cutting tool for this purpose also, the cost of the air duct will not be increased significantly and a further degree of freedom is added to the ability to tailor-make the set of openings not provided with guiding portions and openings provided with guiding portions, for specific purposes.

According to a preferred embodiment of the invention, a ratio is provided along a longitudinal extension of the air duct, said ratio being between openings not being provided with guiding portions and openings being provided with guiding portions, said ratio having one value at one position along the longitudinal extension of the air duct, and said ratio having another value at another position along the longitudinal extension of the air duct, and the value of said ratio changing progressively in the longitudinal direction of the air duct.

A well-known problem with air ducts pliable or solid comprising one or more dead-ends is the fact that the entry pressure of the air when entering the air duct is different from the pressure further towards the dead-end(s). This impose a difference in amount of discharged air along the longitudinal extension of the air duct, but it also impose a difference to the degree of entrainment of air along the longitudinal extension of the air duct, meaning that close to the entry the discharged air will have a large velocity component along the longitudinal extension of the air duct whereas far away from the entry the discharged air will have a small velocity component along the longitudinal extension of the air duct. Since the guiding portions are used to prevent entrainment different specifications of the set of openings and openings with guiding portions is needed whether the set is to be applied near or away from the entry of the air duct. By taking this into account when specifying the set of openings and openings with guiding portions a more uniform distribution of air along the whole length of the air duct is possible or otherwise non-uniform distribution should that be the intention.

According to a preferred embodiment of the invention, the guiding portion is provided at the openings by a separate element made from a material separate from the material of the pliable wall, said separate element being attached to the pliable wall.

In some embodiments of the invention it might be more appropriate to use another material for the guiding portions, which then requires a further process step namely the assembly of wall and guiding portion. However if the required properties of the guiding portion cannot be satisfied by the altered or un-altered material of the pliable wall the guiding portion might be constituted by a different material and assembled with the pliable wall along the boundary of the opening.

According to an embodiment of the invention, the guiding portion is provided along the boundary of the opening by the non-through cut part of the material, which the pliable wall is made of, said non-through cut part constituting a straight line along the boundary of the opening.

According to an embodiment of the invention, the guiding portion is provided along the boundary of the opening by the separate element made from a material separate from the material of the pliable wall, said separate element being attached to the pliable wall along a straight line.

According to an embodiment of the invention, at least part of the openings provided with a guiding portion constitutes single holes in the pliable wall, and where each said guiding portion constitutes a portion made of the material of the pliable wall and at least partly covering said single hole of each opening.

According to an embodiment of the invention, at least part of the openings provided with a guiding portion constitutes a plurality of holes in the pliable wall, and where each said guiding portion constitutes a separate element, made from a material separate from the pliable wall, and at least partly covering said plurality of holes of each opening.

According to an embodiment of the invention, the guiding portion is connected to the edge of the opening along a single line segment of the opening.

According to an embodiment of the invention, the guiding portion is connected to the edge of the opening along multiple line segments of the opening.

According to an embodiment of the invention, an air flow A2, when air is discharged through the air duct, is discharged through openings not being provided with guiding portions, said air flow A2 being directed in an angle α being larger than 90° in relation to a longitudinal direction of the air duct.

According to an embodiment of the invention, an air flow A3, when air is discharged through the air duct, is discharged through openings being provided with guiding portions, said air flow A2 being directed in an angle β being smaller than 90° in relation to a longitudinal direction of the air duct.

According to an embodiment of the invention, a final air flow A4, when air is discharged through the air duct, is a mixture of air flow A2 discharged through openings not being provided with guiding portions and air flow A3 discharged through openings being provided with guiding portions, said final air flow A4 being directed in an angle γ being substantially 90° in relation to a longitudinal direction of the air duct.

The aspects of the present invention may each be combined with any of the other aspects. These and other aspects of the invention will be apparent from and elucidated with reference to the embodiments described hereinafter.

Throughout this document the terms “comprising” or “comprises” do not exclude other possible elements or steps. Also, the mentioning of references such as “a” or “an” etc. should not be construed as excluding a plurality.

### BRIEF DESCRIPTION OF THE DRAWINGS

The invention will be described in more detail with reference to the accompanying figures. The figures show one way of implementing the present invention and is not to be construed as being limiting to other possible embodiments falling within the scope of the claim set.

FIGS. 1 and 2-4 show the air duct of the invention in different perspective and plane views.

FIG. 2 show an air duct and air flow from the duct according to prior art, in a plane view.

FIG. 5 shows different configurations of an array of openings with guiding portions.

FIG. 6 shows different shapes of guiding portions apart from that shown in FIGS. 1 and 2-4.

### DETAILED DESCRIPTION OF THE PREFERRED EMBODIMENT

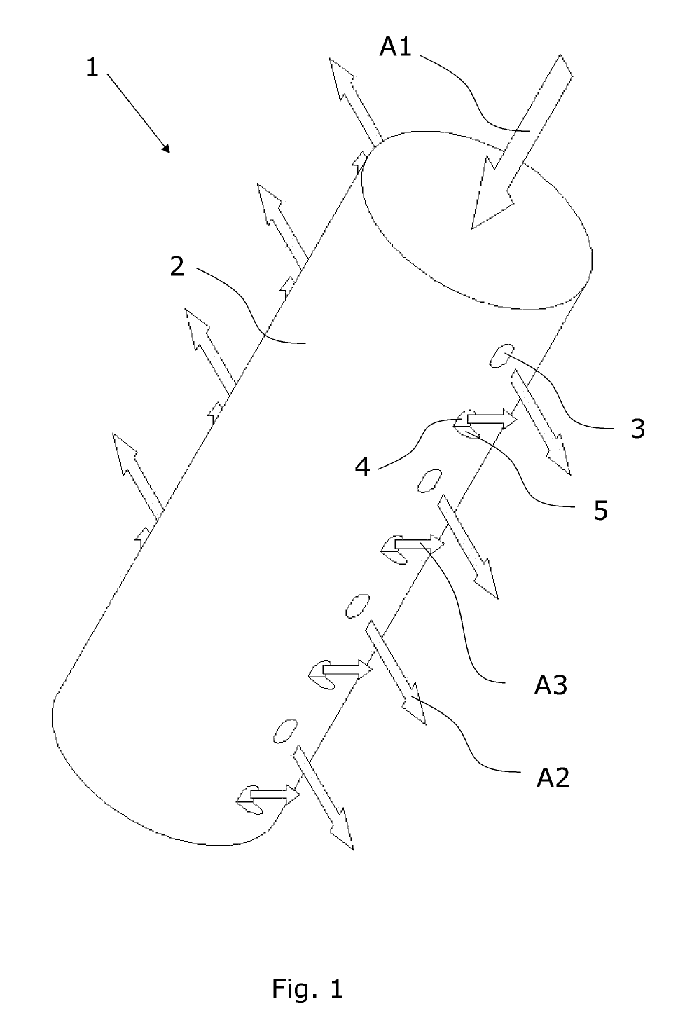

FIG. 1 shows an embodiment of a directional flow-controlled air duct 1. The air duct 1 comprises a pliable wall 2 enclosing a volume through which a main air flow A1 is directed. The main air flow A1 is received in the air duct from a central air-condition system such as a heating/cooling system, an air cleaning system, an air dehumidifying system etc. Along an elongate direction of the air duct 1 a first set of openings 3 and a second set of openings 4 is positioned in the pliable wall 2 for discharging the air from the air duct.

The openings of the second set of openings 4 are provided with guiding portions 5 for guiding the air discharged from the second set of openings 4. The air discharged through the first set of openings 3 will constitute a non-guided air flow A2 and the air discharged through the second set of openings 4 will be guided by the guiding portions 5 and constitute a guided air flow A3.

The guiding portions 5 of the second set of openings 4 are provided by a partial cutout of the pliable material of the air duct. The partial cutout is performed by a through cut of the pliable material along one part of the boundary of the openings 4 thereby formed, and by a non-through cut along another part of the boundary of the openings 4 formed by the through cut. Thereby, a flap-like structure is provided as the guiding portion 5.

The resilience of the material of the air duct, along the non-through cut part of the boundary of the hole, dictates how much the guiding portion will bend outwards depending on the flow volume and the flow speed of the air being discharged from the openings 4.

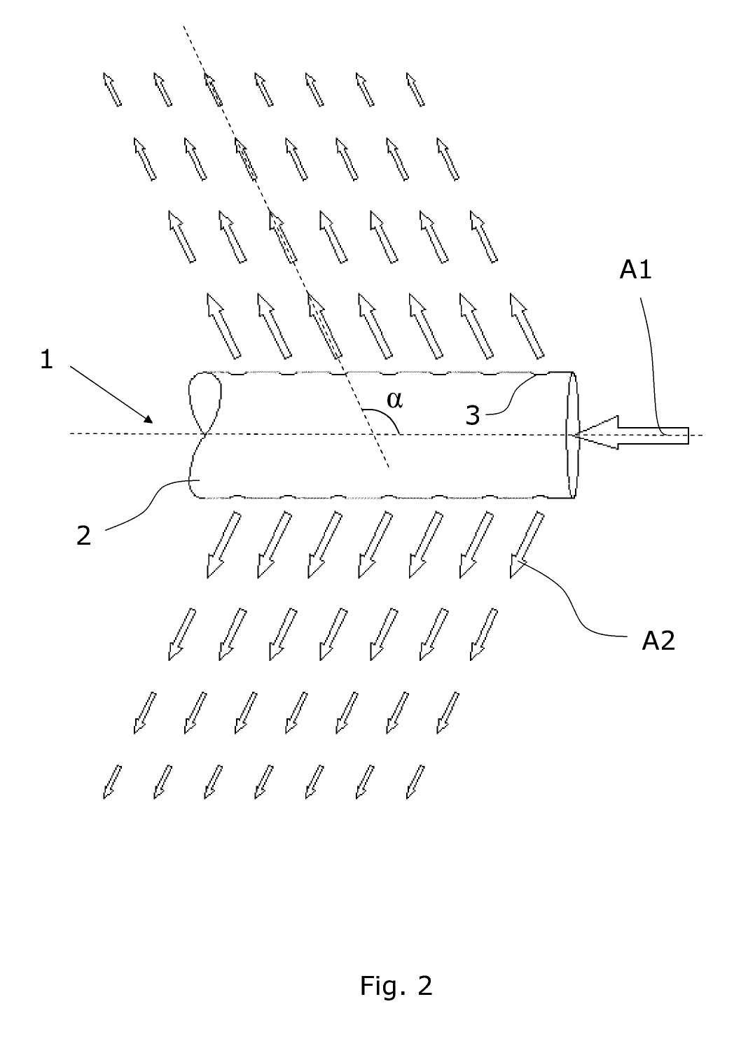

FIG. 2 shows an embodiment of an air duct according to the prior art, where air is discharged from an air duct 1 through a set of openings 3 in a pliable wall 2. The set of openings 3 does not comprise guiding portions as the guiding portions shown and described with reference to e.g. FIG. 1. Air discharged from such an air duct not provided with guiding portions result in a non-guided air flow A2. The air flow A2 will be discharged through the openings 3 in an angle α being an obtuse angle in relation to the longitudinal extension of the air duct. The air flow phenomenon shown in FIG. 2 is called entrainment.

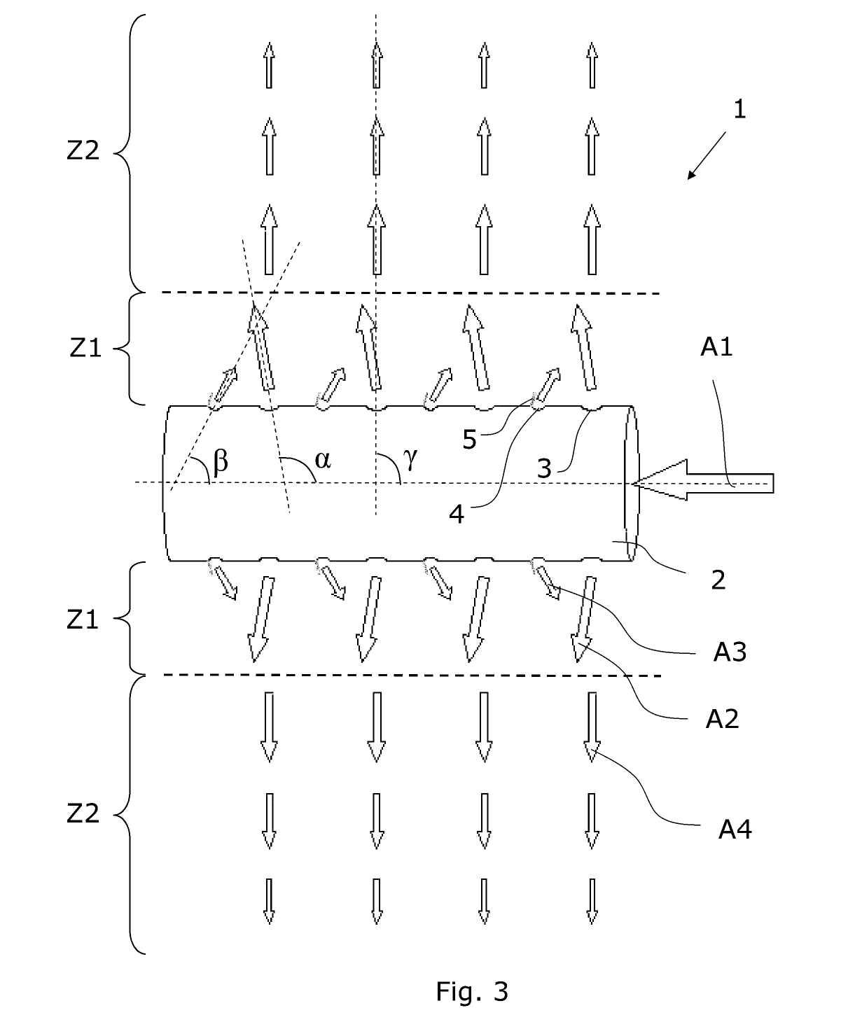

FIG. 3 shows an embodiment of a directional flow-controlled air duct 1. The air duct 1 is similar to the embodiment shown in FIG. 1. The air discharged through the first set of openings 3 will constitute a non-guided air flow A2 and the air discharged through the second set of openings 4 will be guided by the guiding portions 5 and constitute a guided air flow A3 The airflow from the first and second set of openings A2, A3 will mix in a pre-mixing zone Z1 and constitute a resulting air flow A4 outside the pre-mixing zone Z1 in a post-mixed zone Z2.

The air flow A2 is discharged through the openings 3 in the angle α being an obtuse angle in relation to the longitudinal extension of the air duct. The air flow A3 will be discharged through the openings 4 in an angle β being a smaller angle than the angle α in relation to the longitudinal extension of the air duct. In an alternative embodiment, the air flow A3 may be discharged through the openings 4 in an angle β being a larger angle than the angle α in relation to the longitudinal extension of the air duct.

In the simplified flow picture shown in FIG. 3 the airflows A2,A3 are mixed in the mixing zone Z1 and results in a mixed air flow A4 flowing in an intended angle γ in relation to the longitudinal extension of the air duct.

Thus, under given air flow conditions through the air duct, the guiding portions 5 of the openings 4 assist in the air flow A3 being discharged in an angle β smaller than the angle α in relation to the longitudinal extension of the air duct than the angle α shown in FIG. 2.

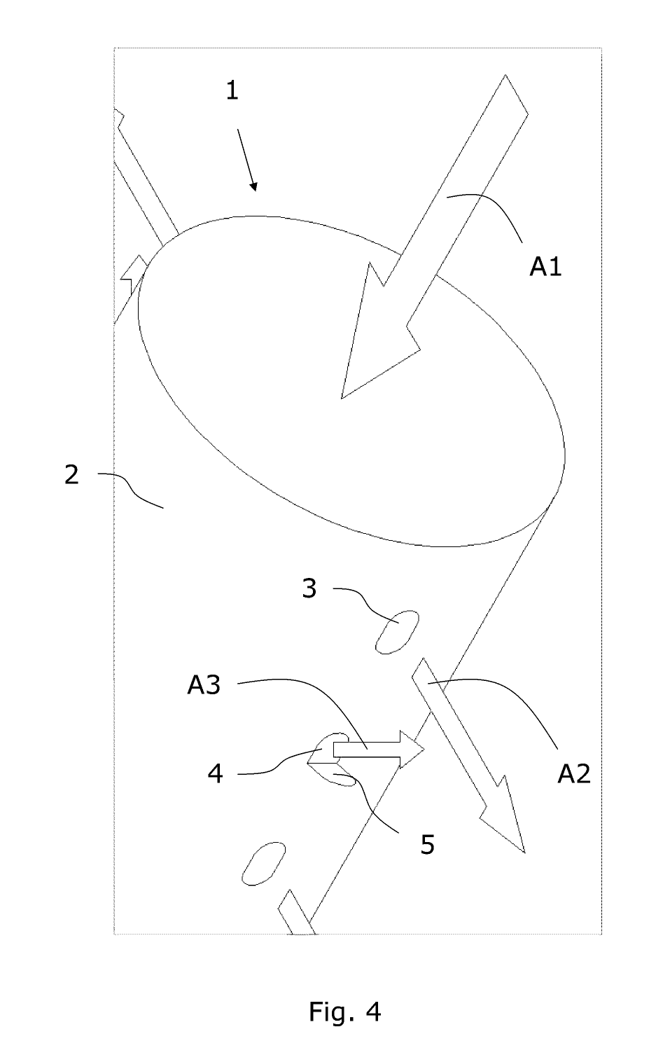

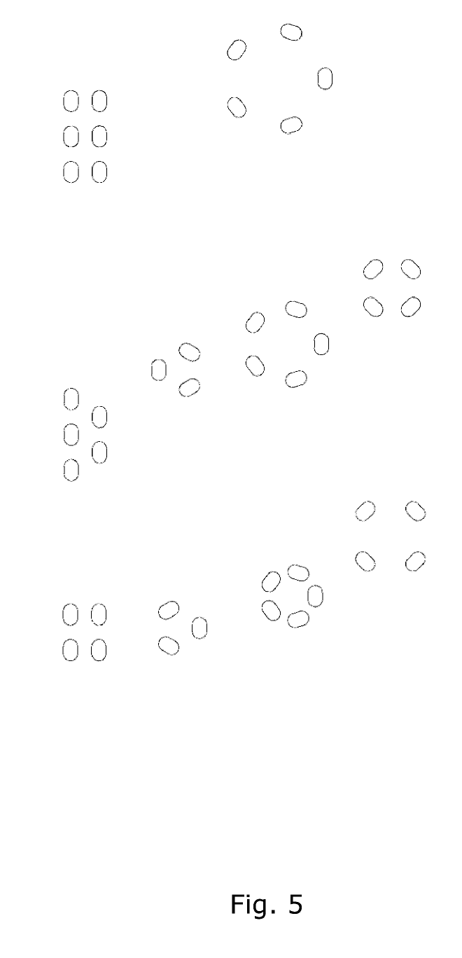

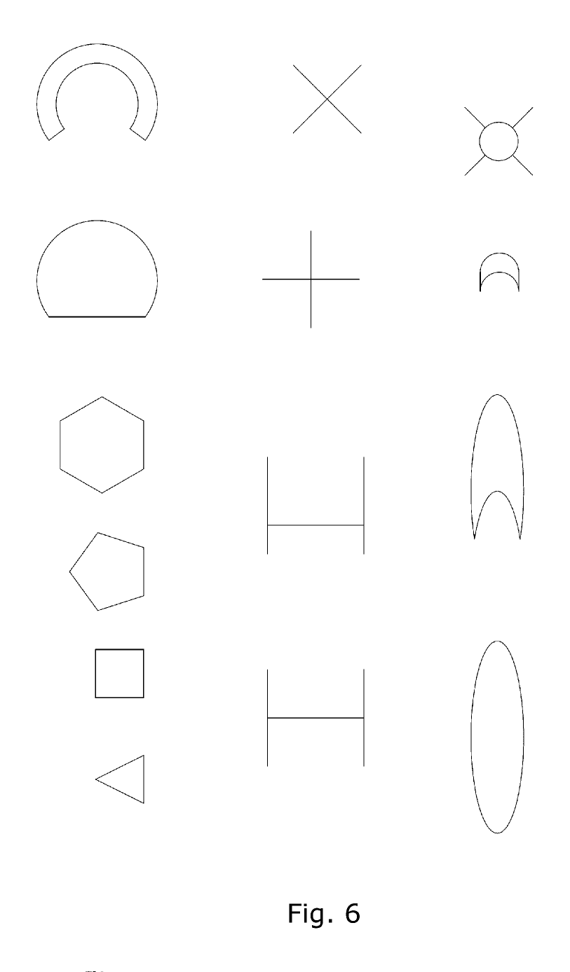

FIG. 4 shows a close-up of an embodiment of a directional flow-controlled air duct 1. The air duct 1 is similar to the embodiment shown in FIG. 1.

It is to be understood that the embodiment shown in the figures including FIG. 4 is by way of example only. Other shapes may be envisaged of the guiding portions, other orientations may be envisaged of the guiding portions and thus of the air flow from the openings 4 provided with the guiding portions, and other positions may be envisaged of the openings 4 provided with the guiding portions 5, positions in relation to the position of the openings 3 without guiding portions.

In the embodiment shown, under the air flow conditions given through the air duct, the guiding portions 5 of the openings 4 assist in the air flow A3 being discharged in an angle β being an angle smaller than α in relation to the longitudinal extension of the air duct.

By optimizing the size and the shape of the guiding portions and/or by optimizing the position of the openings 4 in relation to the position of the openings 3, an optimal air flow A3 discharged through the openings 4 may be obtained, said air flow A3 being optimal in relation to maximizing ventilation capability in the exterior environment of the air duct and/or in relation to minimizing draught in the in the exterior environment of the air duct.

In the embodiment shown, the openings 4 are provided with guiding portions being directed only one way in relation to the longitudinal extension of the air duct. In alternative embodiments, one or more of the openings may be provided with guiding flaps being directed the opposite way in relation to the longitudinal extension of the air duct, i.e. the guiding portions being directed in the same direction, as the air flow A1.

In the embodiment shown, the openings 4 are provided with guiding portions being directed in the same direction as the longitudinal extension of the air duct. In alternative embodiments, one or more of the openings 4 may be provided with guiding flaps 5 being directed obliquely, seen along the surface of the air duct, in relation to the longitudinal extension of the air duct, i.e. the guiding portions being directed along an angle between 0° and 90°, possibly being directed perpendicular, even being directed in along an angle between 90° and 180°, to the longitudinal extension of the air duct.

In the embodiment shown, the openings 3 are shown along a straight line with the openings 4, with guiding portions 5, lying in-between along the same straight line.

In an alternative embodiment, the openings 3 is an array of smaller holes, e.g., four holes lying rectangularly in immediate vicinity of each other, said arrays configuring a straight line parallel with the longitudinal extension of the air duct, and the openings 4 lying along a straight line, said straight line being the same as configured by the arrays.

In another alternative embodiment, the openings 3 are either singular holes or arrays of smaller holes, e.g., four holes lying rectangularly in immediate vicinity of each other, said singular openings or arrays configuring a zigzag along the longitudinal extension of the air duct. The openings 4 provided with guiding portions is also configuring a zigzag along the longitudinal extension of the air duct, but the zigzag of the openings 4 being opposed to the zigzag of the openings 3. Peaks of said zigzag of the openings 4 are also opposed to peaks of the zigzag of the openings 3. Thereby, the openings 4 lie displaced from the singular holes 3 or the arrays of smaller holes 3, along a circumference of the air duct.

The air discharged from the openings 4 and being deflected when discharged may be discharged along the longitudinal extension of the air duct or may alternatively or additionally be directed tangentially in relation to the circumference of the air duct.

In all alternative embodiments mentioned, the technical effect obtained is the air flow A2 being discharged through openings 3 being directed along an angle α and the air flow A3 being discharged through openings 4 with guiding portions 5 being directed along an angle β and the two air flows A2, A3 resulting in a mixed air flow A5 flowing away from the air duct closer to an intended angle γ in relation to the longitudinal extension of the air duct, than the angle α if no openings 4 with guiding portions 5 were provided, such as the embodiment shown in FIG. 2

Although the present invention has been described in connection with the specified embodiments, it should not be construed as being in any way limited to the presented examples. The scope of the present invention is set out by the accompanying claim set.

The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous

What is claimed is:

1. A directional flow-controlled air duct for distributing air, said air duct having a pliable wall comprising a plurality of openings for discharging the air through the plurality of openings, and said air duct comprising:
at least a number of said plurality of openings with a guiding portion for guiding the air through the openings, wherein said guiding portion, when air is discharged through the plurality of openings provided with guiding portions, is deflected by the air from the opening, and said guiding portion resulting in the air, when air is discharged through the plurality of openings being provided with guiding portions, is directed along the guiding portion.

2. The air duct according to claim 1, wherein the guiding portion is provided by a through cut, along a boundary of the opening, of a first part of the material, which the pliable wall is made of, and by a non-through cut, also along the boundary of the opening, of another part of the material, which the pliable wall is made of.

3. The air duct according to claim 1, wherein the openings comprise:
a first set of openings not provided with guiding portions, said first set of openings resulting in air, when discharged through said first set of openings, constituting an air flow discharged in a first direction (A2), and
at least a second set of openings provided with guiding portions, said at least second set of openings resulting in air, when discharged through said at least second set of openings, constituting an air flow discharged in a second direction (A3), wherein a mixed air flow from the first set of openings and from the at least second set of openings is discharged in a third direction (A4) and constitutes a final air flow in a predefined distance from the air duct in a predefined direction.

4. The air duct according to claim 2, wherein the other part of the material, which the pliable wall is made of, and which is non-through cut along the boundary of the opening, has a texture that is different than a texture in immediate vicinity of said other part, wherein said different texture of the other part is provided by heat treatment of the material which the pliable wall is made of, wherein said different texture of the other part resulting in the guiding portion, when air is discharged through the plurality of openings provided with guiding portions, is deflected from the opening a certain degree depending on a flow speed and a flow volume of the air being discharged.

5. The air duct according to claim 1, wherein a ratio is provided along a longitudinal extension of the air duct, said ratio being between openings not being provided with guiding portions and openings being provided with guiding portions, said ratio having one value at one position along the longitudinal extension of the air duct, and said ratio having another value at another position along the longitudinal extension of the air duct, and the value of said ratio changing progressively in the longitudinal direction of the air duct.

6. The air duct according to claim 1, wherein the guiding portion is provided at openings by a separate element made from a material separate from the material of the pliable wall, said element being attached to the pliable wall.

7. The air duct according to claim 1, wherein the guiding portion is provided along the boundary of the opening by the non-through cut part of the material, which the pliable wall is made of, constituting a straight line along the boundary of the opening.

8. The air duct according to claim 6, wherein the guiding portion is provided along the boundary of the opening by the separate element made from a material separate from the material of the pliable wall, wherein said separate element being attached to the pliable wall along a straight line.

9. The air duct according to claim 1, wherein at least part of the openings provided with a guiding portion constitutes single holes in the pliable wall, and wherein said guiding portion constitutes a portion made of the material of the pliable wall, and said guiding portion at least partially covers said single hole of each opening.

10. The air duct according to claim 1, wherein at least part of the openings provided with a guiding portion constitutes an array of holes in the pliable wall, and wherein said guiding portion constitutes a separate element made from a material separate from the pliable wall, and said guiding portion at least partly covers said array of holes of each opening.

11. The air duct according to claim 1, wherein the guiding portion is connected to the edge of the opening along a single line segment of the opening.

12. The air duct according to claim 1, wherein the guiding portion is connected to the edge of the opening along multiple line segments of the opening.

13. The air duct according to claim 1, wherein the air flow in the first direction (A2), when air is discharged through the air duct, is discharged through openings without guiding portions, and, wherein said air flow (A2) is directed in an angle α that is larger than 90°, in relation to a longitudinal direction of the air duct.

14. The air duct according to claim 1, wherein an air flow in the second direction (A3), when air is discharged through the air duct, is discharged through openings that are provided with guiding portions, wherein said air flow (A3) is directed in an angle β that is smaller than 90°, in relation to a longitudinal direction of the air duct.

15. The air duct according to claim 13, wherein the final air flow (A4), when air is discharged through the air duct, is a mixture of air flow (A2) discharged through openings that are not provided with guiding portions and air flow (A3) discharged through openings that are provided with guiding portions, wherein said final air flow (A4) is directed in an angle γ that is between 60° and 90°, in relation to a longitudinal direction of the air duct.

16. The air duct according to claim 14, wherein the final air flow (A4), when air is discharged through the air duct, is a mixture of air flow (A2) discharged through openings that are not provided with guiding portions and air flow (A3) discharged through openings that are provided with guiding portions, wherein said final air flow (A4) is directed in an angle γ that is between 60° and 90°, in relation to a longitudinal direction of the air duct
